(19) United States
(12) Patent Application Publication
(10) Pub. No.: US 2022/0007251 A1
(43) Pub. Date: Jan. 6, 2022

(54) USING LOCATION INDENTIFIER SEPARATION PROTOCOL TO IMPLEMENT A DISTRIBUTED USER PLANE FUNCTION ARCHITECTURE FOR 5G MOBILITY

(71) Applicant: Telefonaktiebolaget LM Ericsson (publ), Stockholm (SE)

(72) Inventors: David Ian ALLAN, San Jose, CA (US); Joel HALPERN, Leesburg, VA (US)

(73) Assignee: Telefonaktiebolaget LM Ericsson (publ), Stockholm (SE)

(21) Appl. No.: 17/288,856

(22) PCT Filed: Oct. 26, 2018
(86) PCT No.: PCT/IB2018/058409

§ 371 Date: Apr. 26, 2021

(51) Int. Cl. H04W 36/22; H04W 36/32; H04W 40/36; H04W 76/30; H04W 36/00

(52) U.S. Cl. CPC H04W 36/22; H04W 36/32; H04W 36/0016; H04W 76/30; H04W 40/36

(57) ABSTRACT

Improved handover processing in a cellular communication network to enable mobility within the cellular communication network without anchor points by way of a source tunnel router (TR) that forwards traffic destined for a user equipment (UE) that is transferring its connection to a target gNodeB, a target user plane function (UPF) and a target TR, as well as by way of the target tunnel router (TR) and target gNodeB, where the target TR and target gNodeB relay traffic between a user equipment (UE) and other devices connected to the cellular communication network. The handover processing by the source TR includes receiving a routing locator (RLOC) of the target TR connected to the target UPF and the target gNodeB from a session management function (SMF), redirecting traffic with an endpoint identifier (ED) of the UE to the target TR, receiving a release message from the SMF, and removing state for the EID of the UE. The processing by the target TR includes receiving redirected traffic for the UE from a source TR, receiving upstream traffic from the UE, forwarding the upstream traffic to a correspondent, and sending an update to a location identifier separation protocol (LISP) mapping server (MS) indicating an endpoint identifier (EID) to the target TR identified by routing locator (RLOC) mapping.

### TECHNICAL FIELD

Embodiments of the invention relate to the field of 5th Generation (5G) mobile communication technology and more specifically, to a method and system for using location identifier separation protocol (LISP) to enable a distributed user plane function architecture to improve efficiency in a 5G network by eliminating inefficiency related to the use of anchor points and further methods for efficiently managing loss handover of user equipment between attachment points.

### BACKGROUND

Referring to FIG. 1, cellular communication networks enable user equipment (UE) 101, such as cellular phones and similar computing devices, to communicate using spread spectrum radio frequency communication. The UE 101 communicates directly with a radio access network (RAN). The RAN includes a set of base stations such as 5G new radio (NR) base stations, referred to as gNodeB 103. FIG. 1 is a diagram of an example architecture for a cellular communication system consistent with 5G cellular communication architecture including an example UE 101 communicating with a gNodeB 103 of the network. The gNodeB 103 interfaces with a packet core network or 5G network core (5GC) 115 that connects the UE to other devices in the cellular communication network and with devices external to the cellular communication network.

The 5GC 115 and its components are responsible for enabling communication between the UE 101 and other devices both internal and external to the cellular communication system. The 5GC 115 includes a user plane function (UPF) 105, a session management function (SMF) 107, an access and mobility management function (AMF) 109 and similar components. Additional components are part of the 5GC 115, but the components with less relevance to the handling of the UE 101 and its mobility have been excluded for clarity and to simplify the representation. The UE 101 may change the gNodeB 103 through which it communicates with the network as it moves about geographically. The AMF 109, UPF 105 and SMF 107 coordinate to facilitate this mobility of the UE 101 without interruption to any ongoing telecommunication session of the UE 101.

The AMF 109 is a control node that, among other duties, is responsible for connection and mobility management tasks. The UE 101 sends connection, mobility, and session information to the AMF 109, which manages the connection and mobility related tasks. The SMF handles session management for the UE 101.

The UPF 105 provides anchor points for a UE 101 enabling various types of transitions that facilitate the mobility of the UE 101 without the UE losing connections with other devices. The UPF 105 routes and forwards data to and from the UE 101 while functioning as a mobility anchor point for the UE 101 handovers between gNodeBs 103 and between 5G, long term evolution (LTE) and other 3GPP technologies. The UPF 105 also provides connectivity between the UE 101 and external data packet networks by being a fixed anchor point that offers the UE's Internet Protocol (IP) address into a routable packet network.

As shown in the example simplified network of FIG. 1, a UE 101 communicates with the 5GC 115 via the gNodeB 103 and reaches a correspondent 113, or 121 via UPF 105. In this example, the traffic from the UE 101 would traverse the connected gNodeB 103, and the UPF 105, to reach a correspondent 113. The correspondents 113, 121 can be any device capable of receiving the traffic from the UE 101 and sending traffic to the UE 101 including cellular phones, computing devices and similar devices that may be connected through any number of intermediate networking or computing devices.

### SUMMARY

In one embodiment, a method is implemented by a network device in a cellular communication network, the method to improve handover processing by a source tunnel router (TR) where the source TR forwards traffic destined for a user equipment (UE) that is transferring its connection to a target gNodeB, a target user plane function (UPF) and a target TR to enable mobility within the cellular communication network without anchor points. The method includes receiving a routing locator (RLOC) of the target TR connected to the target UPF and the target gNodeB from a session management function (SMF), redirecting traffic with an endpoint identifier (EID) of the UE to the target TR, receiving a release message from the SMF, and removing state for the EID of the UE.

In another embodiment, a method is implemented by a network device in a cellular communication network, the method to improve handover processing by a target TR and target gNodeB where the target TR and target gNodeB relay traffic between a UE and other devices connected to the cellular communication network to enable mobility within the cellular communication network without anchor points. The method includes receiving redirected traffic for the UE from a source TR, receiving upstream traffic from the UE, forwarding the upstream traffic to a correspondent, and sending an update to a location identifier separation protocol (LISP) mapping server (MS) indicating an EID to the target TR identified by RLOC mapping.

In a further embodiment, a network device in a cellular communication network implements a method to improve handover processing by a source TR where the source TR forwards traffic destined for a UE that is transferring its connection to a target gNodeB, a target UPF and a target TR to enable mobility within the cellular communication network without anchor points. The network device includes a non-transitory computer-readable storage medium having stored therein a handover manager, and a processor coupled to the non-transitory computer-readable storage medium, the processor to execute the handover manager, the handover manager to receive a RLOC of the target TR connected to the target UPF and the target gNodeB from a SMF, to redirect traffic with an EID of the UE to the target TR, to receive a release message from the SMF, and to remove state for the ED of the UE.

In one embodiment, a network device in a cellular communication network implements a method to improve handover processing by a target TR and target gNodeB where the target TR and target gNodeB relay traffic between a UE and other devices connected to the cellular communication network to enable mobility within the cellular communication network without anchor points. The network device includes a non-transitory computer-readable medium having stored therein a handover manager, and a processor coupled to the non-transitory computer-readable medium, the processor to execute the handover manager, the handover manager to receive redirected traffic for the UE from a source TR, to receive upstream traffic from the UE, to forward the upstream traffic to a correspondent, and to send an update to a LISP MS indicating an ED to the target TR identified by RLOC mapping.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of a 5G network architecture.

FIG. 2 is a diagram of one embodiment of a 5G network architecture with non-roaming user equipment communicating with a correspondent.

FIG. 3 is a diagram of one embodiment of a 5G network architecture with data traffic flows when a UE is connected to a home network.

FIG. 4 is a diagram of one embodiment of traffic flow where a tunnel router (TR) is an egress for outbound traffic.

FIG. 5 is a flowchart of one embodiment of a process of the TR to facilitate communication between a UE and a correspondent.

FIG. 6 is a diagram of one embodiment of traffic flow where a TR is an ingress for incoming traffic.

FIG. 7 is a flowchart of one embodiment of a process of an ingress TR to facilitate communication between a UE and a correspondent.

FIG. 8 is a diagram of one embodiment showing the communication routes and types between the components of the network.

FIG. 9 is a diagram of one embodiment of a handover process.

FIG. 10 is a diagram of one embodiment of the handover process call flow.

FIG. 11 is a diagram of additional calls in the handover process call flow.

FIG. 12 is a flowchart of one embodiment of the process for handover at a source tunnel router.

FIG. 13 is a flowchart of one embodiment of the process for handover at a target tunnel router.

FIG. 14A illustrates connectivity between network devices (NDs) within an exemplary network, as well as three exemplary implementations of the NDs, according to some embodiments of the invention.

FIG. 14B illustrates an exemplary way to implement a special-purpose network device according to some embodiments of the invention.

FIG. 14C illustrates various exemplary ways in which virtual network elements (VNEs) may be coupled according to some embodiments of the invention.

FIG. 14D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 14E illustrates the simple case of where each of the NDs implements a single NE, but a centralized control plane has abstracted multiple of the NEs in different NDs into (to represent) a single NE in one of the virtual network(s), according to some embodiments of the invention.

FIG. 14F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 15 illustrates a general-purpose control plane device with centralized control plane (CCP) software, according to some embodiments of the invention.

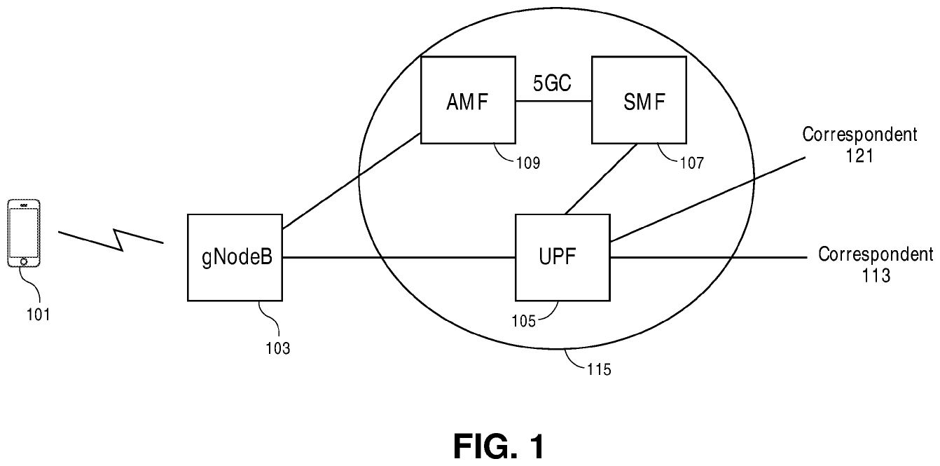

### DETAILED DESCRIPTION

The following description sets forth methods and system for improving the efficiency of bandwidth utilization in 5th Generation cellular communication architecture networks. More specifically, the embodiments provide a method and system for using location identifier separation protocol (LISP) to improve efficiency in a 5G network by eliminating inefficiency related to the use of anchor points. The 5G architecture and the geographic placement of its components is driven by both technical and business considerations and requires specific functionalities and functional distributions to be carried forward in any update to the architecture. The embodiments provide improved efficiency while preserving the key functionalities of the 5G architecture. The embodiments further build on this architecture to improve the efficiency and reliability of the handover process when a user equipment (UE) transitions from one attachment point in the network to another attachment point. These handover processes include the use of filters for managing traffic forwarding and similar processes.

The specific inefficiencies in the 5G network architecture that are addressed include the functions of the user plane functions (UPF) when serving as anchor points. The embodiments utilize identifiers/locator separation and mapping system technology to enable separation of mobility support from other session functions and the distribution of the session functions closer to the edge. Existing mobility components of 5G networks have an inherent inefficiency in that they use tunneling from an “anchor point” to the UE. Such solutions also have a defined architecture that is motivated by both technical and business concerns which require specific functionalities and functional distributions to be carried forward in any next generation mobility architecture. The embodiments eliminate the bandwidth inefficiency of anchor points while preserving the key functionalities and entity relationships embodied in the 5G network architecture.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

LISP is routing technology that provides alternate semantics for Internet Protocol (IP) addressing. This is achieved via the tunneling of identity information, i.e., endpoint identifier (EID), between tunnel routers identified by routing locators (RLOCs). The on-the-wire format is a variation of IP in IP tunneling with simply different semantics associated with the IP addresses located at different points in the stack. Each of these values, the EID and RLOC, have separate address or numbering spaces. Splitting EID and RLOC enables a device to change locations within a LISP network without the identity of the device changing and therefore associated session state (e.g. transmission control protocol (TCP) or IP security (IPSEC)) remains valid independent of the EID's actual point of attachment to LISP network.

The embodiments utilize LISP to avoid the limitations of anchor points in the 5G network architecture. The UPF in the 5G network architecture act as anchor points that also implement specific functionalities not easily dispensed with as they address business and regulatory requirements. The UPF, which acts as a session anchor point for a given subscriber session, normally has an invariant point in the network. The 5G network architecture has split the anchor point into UPF and SMF, where the UPF is the user plane component and the SMF is the control plane component. The embodiments take advantage of the control plane location being invariant and hide how the user plane is handled by having the location of the UPF functionality follow the UE. For example, the UPF session “state” associated with a UE is co-located with the gNodeB that the UE is currently attached to and if the UE changes its attachment point to the network, the location of the UPF session state and functionality will also be moved to the new attachment point. The embodiments use LISP to “hide” the user plane mobility component from peers in the architecture that are not architected for peer mobility. Key elements of the embodiments include connectivity between a distributed UPF in a visited network and a UPF in a home network (home routed traffic in a roaming scenario), and connectivity between a correspondent and a distributed UPF in a home network (non-roaming case). Although the data plane portion of the UPF associated with a specific UE will follow the UE, the control component appears to peers as geographically pinned entity, which replicates the semantics of how a 3GPP network works today. The embodiments are able to be implemented with no negative impacts on the scaling of networks, or the surrounding network functions. All non-UP interfaces from the UPF (legal intercept, policy etc.) are aggregated by the SMF. The embodiments provide a tunnel router (TR) that participates in 5G procedures and is closely linked to the UPF. The UPF and TR are both controlled entities by the SMF and linked. The UPF and TR can be a single entity or broken out as two to simplify mapping between 5G concepts and LISP concepts.

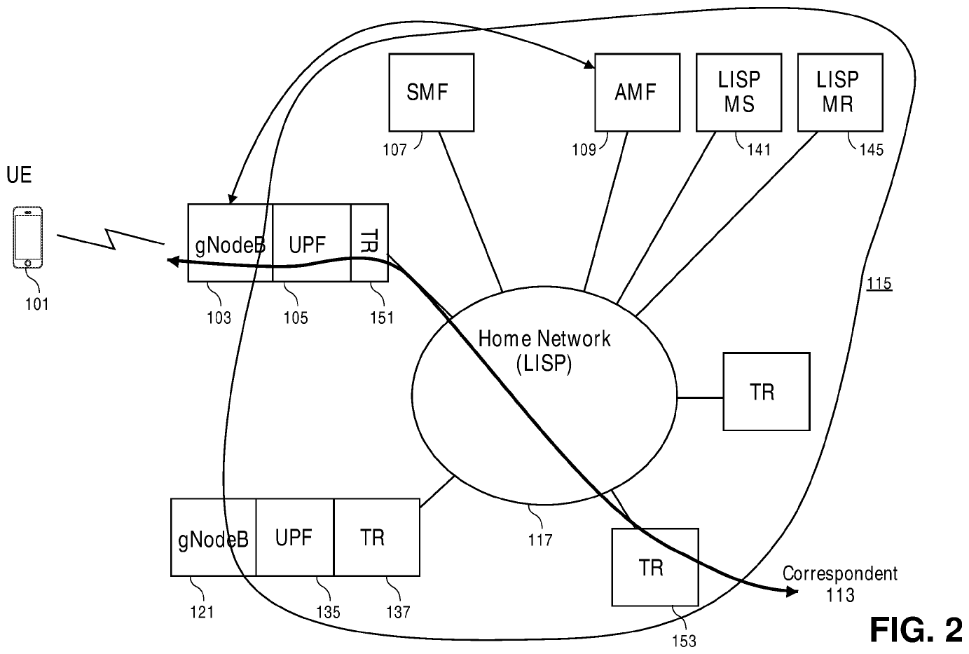

FIG. 2 is a diagram of one embodiment of a 5G network architecture with non-roaming user equipment communicating with a correspondent. In this example illustrated embodiment, the UPF 105 is co-located with a gNodeB 103, such that a UE 101 being served by a home network 117 can connect to the network via the UPF 105 at or near the gNodeB 103. This is facilitated by TRs 151, 153 that forward the data traffic between a UE 101 and correspondent 113 using LISP. This remains true where the UE 101 may move to connect to another gNodeB 121. The UE 101 could move from a source gNodeB 103 to a target gNodeB 121 without interruption to the communication session with the correspondent 113. The state of the UPF 105 can be transferred or synchronized between the UPF instances at the source gNodeB 103 and those at the target gNodeB 121. Any method or process for coordinating the transfer of state and related configuration data from the source gNodeB 103 to the target gNodeB 121 can be utilized.

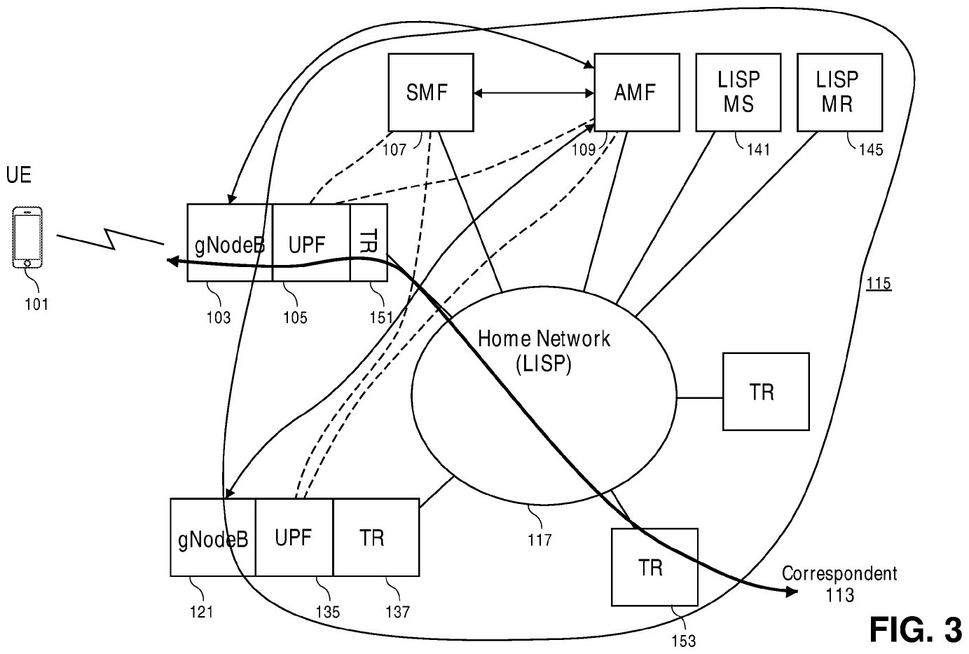

In this example, functions of the UPF 105 are distributed. Distributed refers to the traditional function that was served by an anchor point being delegated to the LISP system, and the policy and forwarding aspects of the UPF itself being moved adjacent to the UE's point of attachment to the network, such that the state associated with stateful functions and session management are required to “follow” the UE when it changed point of attachment to the network. However, one skilled in the art would understand that this configuration is provided by way of example and not limitation. The distribution of the functions of the UPF 105 in combination with the use of LISP can be utilized in other configurations where different permutations of the functions are distributed. Examples illustrating some of the variations are described herein below with reference to FIGS. 3-5.

Returning to the discussion of FIG. 2, the control plane functions of the SMF 107 and AMF 109, remain in the 5GC 115. The 5GC 115 has been augmented with a LISP mapping server (MS) 141 and a LISP map resolver (MR) 145. The LISP MS 141 manages a database of EID and RLOC mappings that are determined from communication with TRs 151, 153. The LISP MS 141 receives EID information about connected devices from TRs 151, 153 that are stored in the database and associated with the respective TRs 151, 153. Similarly, the LISP MR 145 handles map requests from the TRs 151, 153 when serving as ingress TRs and uses the database to find an appropriate egress TR to reach a destination EID. Thus, these components provide seamless session mobility for the UE 101 along with the use of TRs 151, 153. Seamless session mobility refers to the UE 101 being reachable while preserving an identity in the form of an IP address while changing points of attachment to the network.

The distributed UPFs 105 can be instantiated at each gNodeB with a logically separate instance for each connected UE 101. Thus, the state and similar configuration are specific to the UE 101 and can be transferred or shared with other instances located at other gNodeBs to facilitate handover operations.

FIG. 3 is a diagram of one embodiment of a 5GC network architecture with data traffic flows when a UE is connected to a home network. General packet radio service (GPRS) tunneling protocol (GTP) is utilized to carry user traffic from a gNodeB to the 5GC network. Control information is exchanged (dashed lines) between the gNodeB 103, AMF 109, SMF 107, and the UPF 105. GTP-U is normally utilized to convey data/user plane traffic from a gNodeB to a UPF 105. In the illustrated embodiment, the gNodeB 103, and UPF 105 have been collapsed into a single node, hence there is no actual GTP-U component.

A UE 101 served by a home network 117 is shown. The UE 101 is connected to a source gNodeB 103 that may be co-located with UPF 105 as well as a TR 151. The N2 interface is utilized to communicate control plane information between the source gNodeB 103 and the AMF 109. Similar control exchange occurs between other 5GC components (not illustrated) as well as between the SMF 107 and the AMF 109.

When the UE 101 sets up a protocol data unit (PDU) session it will either be directly connected to its home network or roaming. During the course of control exchange the SMF 107 will select the UPF to serve the UE 101 for the requested session. For a directly connected UE the traffic is eligible for local breakout using LISP, the selected UPF 105 will be collocated with the gNodeB 103.

LISP routing (thick solid line) is used to send the user plane traffic across the 5GC from an ingress TR 151 to an egress TR 153 to enable communication between the UE 101 and the correspondent 113. A TR serves as an ingress or egress TR relative to the direction of data traffic such that a given TR is an ingress TR where traffic is being tunneled to be forwarded to the egress TR and an egress TR when it receives traffic from the ingress TR. In the event of a handover from a source gNodeB 103 to a target gNodeB 121, control plane exchange is utilized to coordinate the transfer or synchronization of state from the source gNodeB 103, UPF 105 to the target gNodeB 121, and target UPF 135.

In the example, the TR 151 co-located with the UPF 105 determines the RLOC serving the correspondent, which may be the egress TR 153. The RLOC may be determined using the destination EID from the data traffic by contacting the LISP MR 145. After a transfer of the UE 101 to a target gNodeB 121, the local instance of the UPF 135 will similarly use the destination EID to forward the traffic via the local TR 137 to the egress TR 153 without interruption.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

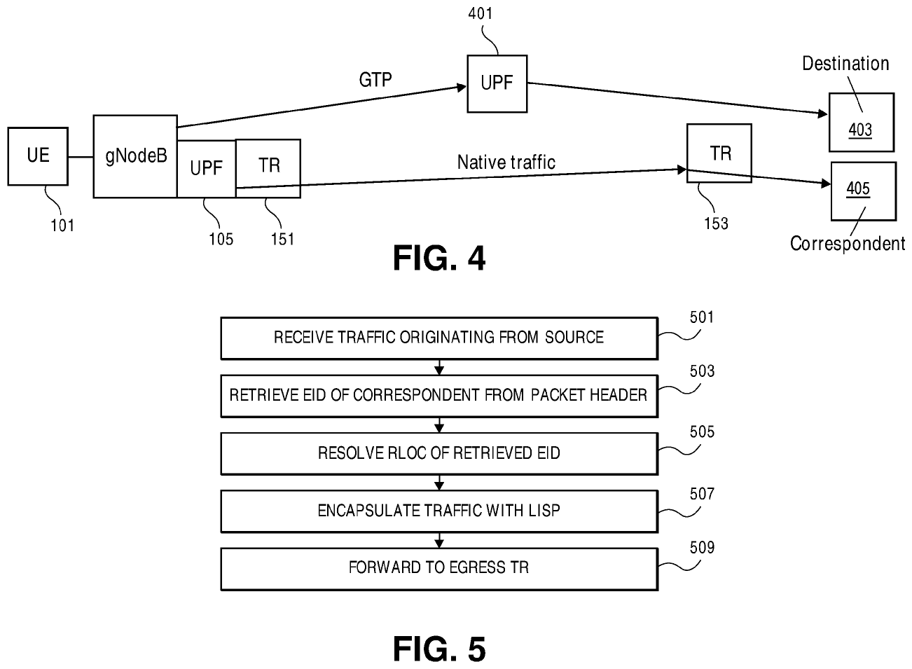

FIG. 4 is a diagram of one embodiment of traffic flow where a tunnel router (TR) is an egress for outbound traffic. UE 101 traffic is mapped to a PDU session, which may be home routed or locally broken out using LISP depending on the relationship of the UE with the operator of the network the UE is attached to. A UE that is roaming is considered to be in a visited network, but the subscription is associated with a home network. A non-roaming UE 101 is connected directly to its home network. Traffic intended for local breakout is forwarded to the local UPF 105 where policies are applied, then passed to the ingress TR 151, where the traffic is examined for its destination by the UPF 105 to determine an EID/RLOC for a destination, is encapsulated and forwarded to the associated egress TR 153 and from there onto the correspondent 405. Roaming traffic is GTP encapsulated and routed to a remote UPF 401 in the UE's home network where and policies may be applied by the UE's home network operator prior to forwarding the traffic to the destination 403.

FIG. 5 is a flowchart of one embodiment of a process of the TR to facilitate communication between a UE and a correspondent. The process is implemented by the ingress/local TR at the gNodeB that is coupled to the UE.

The process of the TR begins in response to the receiving of traffic originating at the UE or similar source (Block 501). The traffic may have passed through the UPF. The TR examines the packet header, which is a native header (e.g., an IP header) and from the header information determines the correspondent EID from the packet header (Block 503). If the TR has not already resolved the EID to an RLOC, it does so by querying the LISP MR or similar service to determine the RLOC of the egress TR for the correspondent (Block 505).

The received packet is then encapsulated in a LISP packet where the LISP header is added to the received packet, which is then encapsulated in an IP packet addressed to the RLOC of the egress TR (Block 507). The encapsulated packet can then be forwarded over the core network toward the egress TR (Block 509). The egress TR removes the LISP encapsulation and forwards the packet on to the correspondent on the basis of the EID in the decapsulated packet.

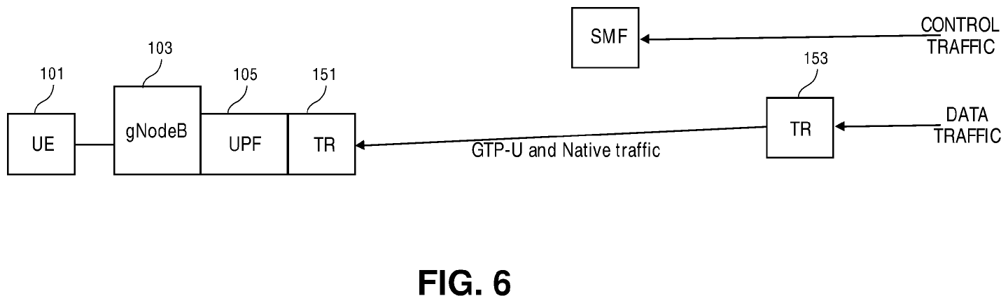

FIG. 6 is a diagram of one embodiment of traffic flow where a TR is an ingress for incoming traffic. In this case the ingress TR 153 is sending traffic toward the UE 101 from a correspondent or similar source. The traffic is received by the ingress TR 153 and the destination address (i.e., the EID of the UE) is examined. The EID is mapped to the RLOC of the egress TR 151. This information has either been cached locally or obtained via the LISP MR. This data traffic is encapsulated by the ingress TR 153 to be forwarded via LISP to the TR 151 at the gNodeB 103 where the UE 101 is currently attached. Control traffic is delivered as is, subject to normal internet service provider (ISP) filtering policies, without any use of LISP. Similarly, GTP-U encapsulated roaming traffic is forwarded without LISP encapsulation or EID/RLOC resolution.

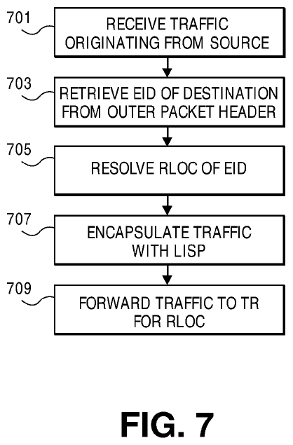

FIG. 7 is a flowchart of one embodiment of a process of an ingress TR to facilitate communication between a UE and a correspondent. The process is initiated when traffic is received originating from the correspondent or similar source (Block 701). The received traffic is not GTP encapsulated, it is native (e.g., IP) traffic. The destination address in the packet header is the EID of the UE, which is retrieved for further processing (Block 703). The destination EID is resolved to determine the RLOC of the egress TR (Block 705). The ingress TR may LISP encapsulate the traffic (Block 707). The traffic is then forwarded to the egress TR (Block 709), which removes the LISP encapsulation and passes the traffic on to the UPF to be forwarded to the UE.

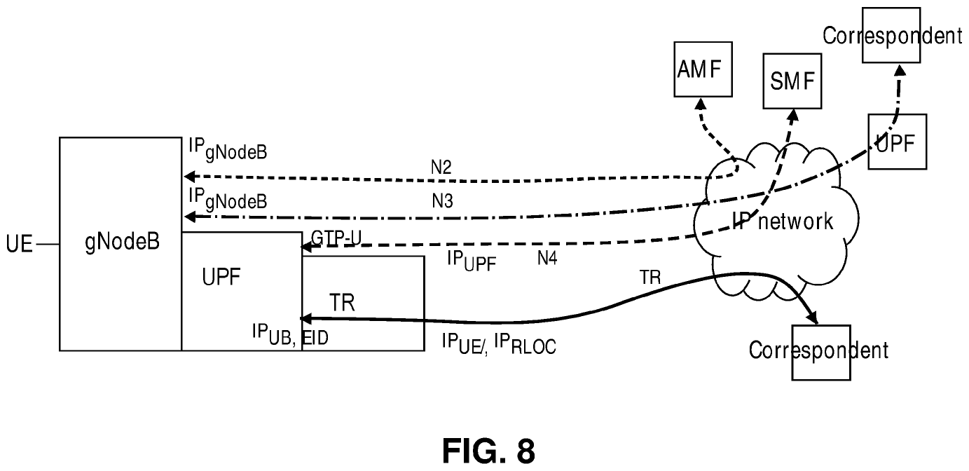

FIG. 8 is a diagram of one embodiment showing the communication routes and types between the components of the network. The illustration shows that a TR co-located with distributed UPF at a gNodeB may see inbound traffic that may be addressed to the local UPF. Non-GTP (i.e., native) traffic from a correspondent is addressed to a UE's EID, which is delivered to the UPF component having transited the ingress and egress TRs. UPF control plane traffic from the SMF via interface N4 is directed to the local UPF. GNodeB control traffic (e.g., from the AMF) is received via interface N2 with the gNodeB IP address. Roaming traffic is received from correspondents and remote UPFs via interface N3 with the gNodeB IP address.

The embodiments have been described with an example of a LISP domain that corresponds to a single SMF serving area. This would need to be logically true for the life of a PDU session as the SMF would coordinate state migration between the distributed set of UPFs as well as collection of session telemetry. In further embodiments, a tracking area could be instantiated as a subset of the LISP domain by the SMF or AMF. In further embodiments, additional 5GC components could be distributed and co-located with the UPF at the gNodeB. As long as an EID of the UE maps to a correct RLOC for the gNodeB, the associated components in a distributed architecture are reachable via the same RLOC, thus there is a 1:1 correspondence between the gNodeBs and any distributed components. The distributed components are instanced on a per UE basis.

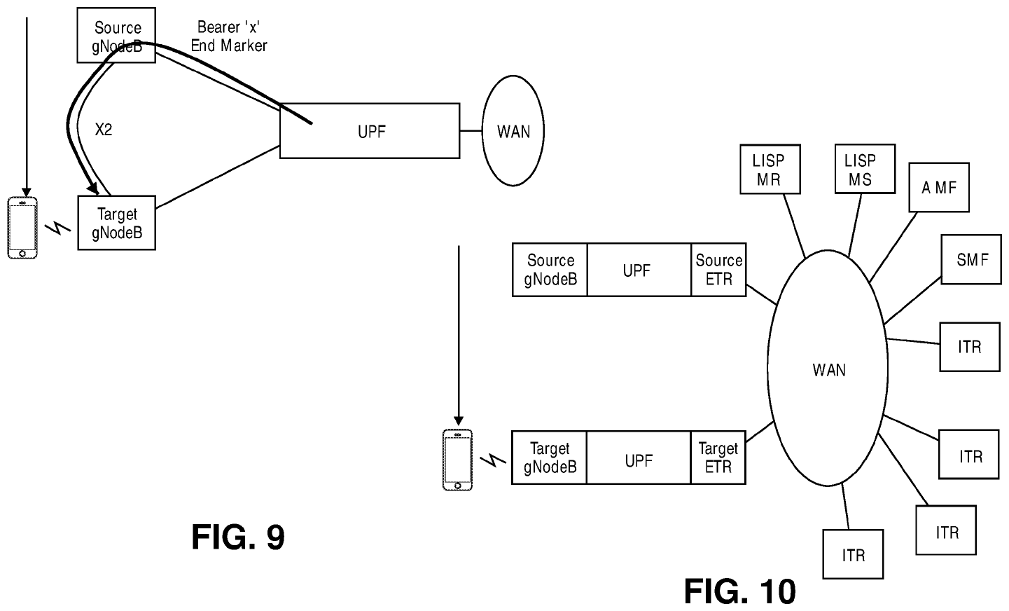

FIG. 9 is a diagram of one embodiment of a handover process. The 5GC architecture is shown on the left. In a handover scenario, the UE drops its connection with the source gNodeB and starts a connection with the target gNodeB. At this point the source gNodeB re-directs all downstream bearer traffic for the UE to the target gNodeB via the X2 interface. This traffic is typically buffered at the target gNodeB until the UE attaches to it. When the UPF is notified that the UE has attached to the target gNodeB, the UPF will switch sending UE traffic directly to the target gNodeB instead of the source gNodeB. At this time, the UPF sends an end marker to the source gNodeB to signal the end of communications via the source gNodeB for each bearer transiting the UPF. The source gNodeB relays each bearer's end marker to the target gNodeB to complete the transition. At this point, the source gNodeB may choose to recover state associated with the re-direction of the bearer to the target gNodeB. The target gNodeB may perform its own unique actions. For example, it may have buffered traffic for a given bearer received directly from the UPF until seeing an end marker for that bearer indicating all older traffic sent via the source gNodeB had been received. That traffic sent directly from the UPF to the target gNodeB may arrive before older traffic sent via the source gNodeB and may result as a consequence of differential queuing delays in the network.

However, in the architecture of the embodiments herein, the mobility as a function moves from in front of the UPF to behind it. In other words, the TRs play a role in the mobility before the traffic reaches the distributed UPF, thus, the TRs must play a role in signaling with the UE and gNodeB regarding the handover and must assume the role of coordinating between the source TR and the target TR to make handover hitless. As shown on the right, there are multiple ingress TRs (ITRs) that enable communication with various correspondents.

The handoff is considered “break before make.” The handoff results in a simplification of the UE in that it is not required to maintain multiple radio connections simultaneously, but instead places additional requirements on the network. 5G procedures such as X2 assisted handoff are designed to mitigate the effects of this, however as specified would be inadequate to deal with LISP as a mobility mechanism. The embodiments are expanded to support seamless handoff between TRs, to provide the function that 5G does (X2 handover as an exemplar). At the same time, the expanded support does not rely on the current 5G architectures inefficiencies in the form of anchor points, and bearer setup. The embodiments include extensions to LISP operation to permit a lossless handoff and to permit coordination of LISP TRs with 5G compatible handoff processes.

In a 5G handoff a handover request has knowledge of the source and target gNodeBs. With knowledge of the target gNodeB, the TR associated with the source gNodeB can use the LISP mapping system to resolve the target TR RLOC and can then coordinate the handoff with it and be able to redirect traffic sent prior to synchronization of other systems with the new EID/RLOC binding. This involves additional messaging, including example message types and processes as described further herein below.

The embodiments seek to provide a handoff process that minimizes loss, buffering and blocking of traffic. The embodiments include a handoff process that may involve some traffic being buffered when no connectivity exists from the source TR to the UE and from the UE to the target TR. Buffering at the UE of upstream traffic, during the period that the UE is changing connectivity from the source gNodeB to the target gNodeB, is not problematic as it is the end-system performing the buffering, not an intermediate system, and therefore is not required to deal with packets in flight. To minimize blocking/buffering, the source TR maintains communication with the UE until the moment the UE disconnects. When the UE disconnects, the source TR will immediately start redirecting traffic to the target TR. The handover process involves an exchange of information or ‘handshake’ that is designed such that the source TR and target TR have a priori knowledge of the intended handover sequence. The target TR thereby can expect traffic related to the handover process and so it does not simply silently discard it.

The embodiments provide a trigger for updating the LISP mapping system. The trigger encompasses a “connect” at the target TR, which fits the model of the TR performing the update and is also the RLOC now associated with the ED. The connect can be considered a trigger for a reoptimization process where the dogleg route far_end_correspondents->source_TR->target_TR can be simplified to far_end_correspondents->target_TR.

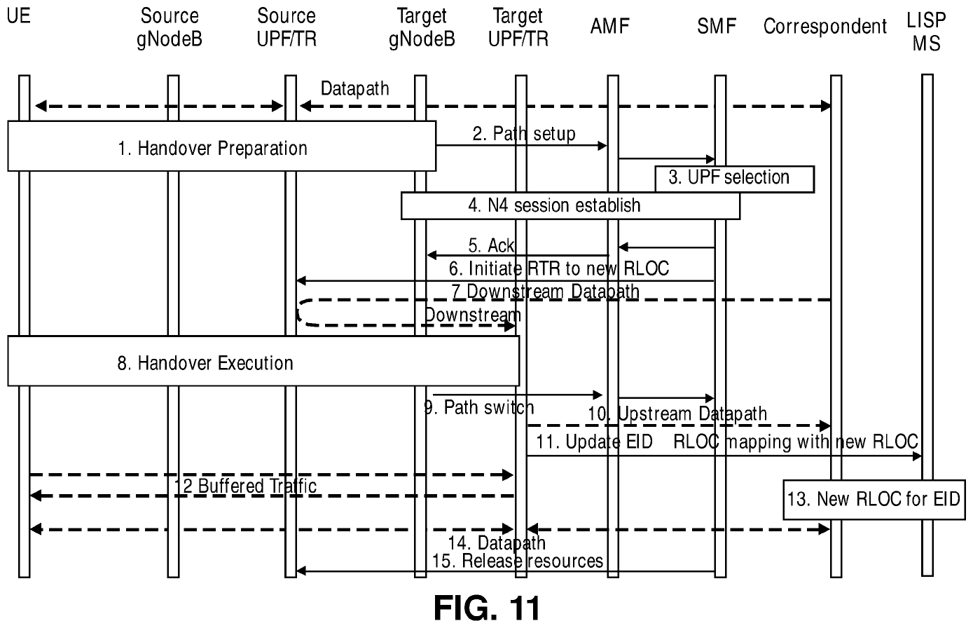

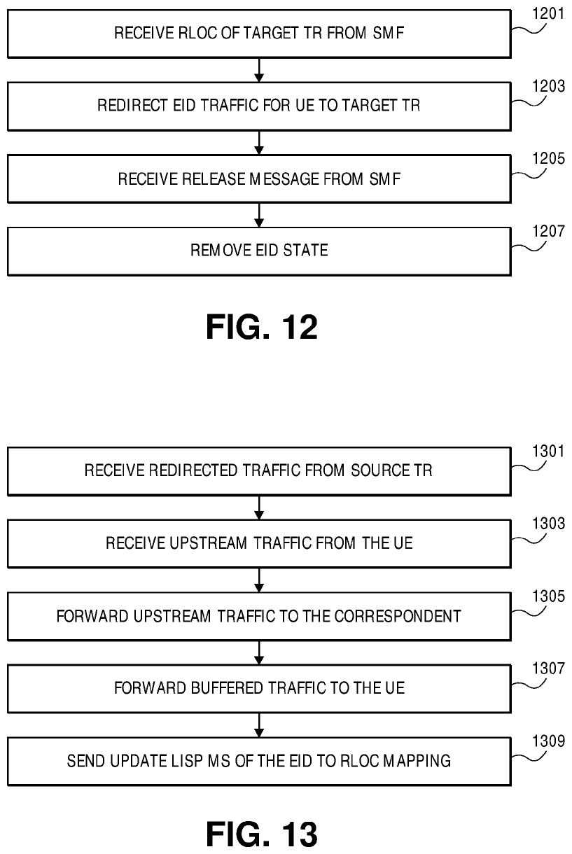

FIGS. 10 and 11 together form a diagram of one embodiment of the handover process call flow. The calls effected by the source TR and target TR are further discussed in relation to the flow charts in FIGS. 12 and 13, respectively. The call flows only illustrate the entities involved in the LISP handoff. Thus, other entities and calls related to the overall handover process may not be illustrated for sake of clarity. As is common and well understood practice, all transactions are acknowledged, and if a transaction initiator does not receive an acknowledgement in a specified time interval, will retry the transaction. This can repeat for a specified number of times before the operation is considered to have failed.

The handover (HO) decision is made with the 5GC network whereby the target gNodeB that will subsequently serve the UE is identified. When the gNodeBs and UPFs received a notification of the initiation of mobility, it triggers the associated TRs to start the processes shown in FIGS. 10-13. Such initiations include but are not limited to radio measurements communicated by the UE to the source gNodeB. Upstream traffic is not a problem as either the UE is attached to the network or buffering traffic during handover, thus the handling of upstream traffic is not illustrated in detail.

The diagrams of FIGS. 10 and 11 illustrate the sequence of message exchange between components from the top down, such that the messages at the top generally take place before or concurrently with those further down. FIGS. 12 and 13 are flowcharts specific to the source TR and target TR, respectively. Initially, as illustrated, a datapath exists between the UE and the source TR and similarly between the source TR and the remote TRs that serves the correspondent for a given communication flow. Subsequently a handover (HO) decision is made to transition the UE to a target gNodeB.

As illustrated in FIG. 10, the process starts with an existing datapath between the UE, a source UPF/TR and a correspondent. In response to a decision to execute a handover, a handover preparation process ensues where the source and target gNodeBs prepare for the handover including synchronizing radio access bearer (RAB) information and similar information. As part of the handover preparation. a setup of a parallel session from the target gNodeB to a target UPF is initiated. The target gNodeB signals the SMF via the AMF to migrate state to the target UPF as part of the handover setup. The SMF is signaled via the AMF to select a target UPF instance co-located with the target gNodeB to service the UE. The SMF programs the target UPF (e.g., using an N4 interface) with session state to mirror the source UPF configuration at the target UPF. The SMF communicates to the target gNodeB via the AMF that a session is ready for handover (e.g., using acknowledgement messages).

The SMF sends the RLOC of the target UPF/TR to the source UPF/TR for handover and redirection of the downstream traffic to the target UPF/TR (Block 1201). The source TR then redirects UE EID destined downstream traffic to the target TR (Blocks 1203 and 1301) once the UE has disconnected. The source TR redirects the UE EID destined downstream traffic by overwriting the RLOC in the received downstream traffic. When the UE connects to the target gNodeB, the target gNodeB sends a path switch message to the AMF, which is relayed to the SMF. The path switch message is an indication that the source UPF session can be taken down after a slight delay. The UE starts sending upstream data via the target UPF/TR (Block 1303). The upstream data traffic is forwarded toward its destination (Block 1305). The target TR, after seeing the UE EID from upstream traffic of the UE, sends an EID/RLOC binding update to LISP Mapping Server (Block 1309).

In parallel, any buffered traffic from the source UPF is sent to the UE (Block 1307). The buffered traffic may include an end marker to signal a completion of the sending of the buffered traffic. The LISP mapping system updates EID/RLOC binding for the correspondent TRs. After receiving the updated bindings, the correspondent TRs direct traffic for the UE using the RLOC of the target TR. The SMF then directs the source UPF/TR to release any session resources associated with the UE (Block 1205). The source UPF/TR responds by removing state related to the UE EID (Block 1207).

The embodiments can utilize a set of messages for the gNodeB to coordinate with the LISP system and architecture as set forth in the example of Table I:

TABLE I

| Message | From | To | Information | Purpose |
|---|---|---|---|---|
| EID | Source | Source | Target | To request a |
| Handover | gNodeB | TR | gNodeB, EID | mobility |
| Request | | | | handover of the |
| | | | | LISP system |
| EID | Source | Source | Some | To make the |
| Handover | TR | gNodeB | information to | EID handover |
| Ack | | | permit Ack to | request reliable |
| | | | be correlated | |
| | | | with the | |
| | | | request | |
| LISP EID | Source | Target | Target TR, | To advise the |
| Handover | TR | TR | EID | target TR that |
| Request | | | | an EID will |
| | | | | move to it |
| LISP EID | Target | Source | Some | To make the |
| Handover | TR | TR | information to | LISP EID |
| Ack | | | permit Ack to | handover |
| | | | be correlated | request reliable |
| | | | with the | |
| | | | request | |
| EID | gNodeB | Local | EID | To advise the |
| Available | | TR | | local TR that |
| | | | | an EID is ready |
| | | | | to send/receive |
| | | | | traffic |
| EID | gNodeB | Local | EID | To advise the |
| Unavailable | | TR | | local TR that |
| | | | | an EID is not |
| | | | | ready to |
| | | | | send/receive |
| | | | | traffic |

These messages are for a client system to inform the LISP system of pending handoff and for the LISP system to perform the associated inter-TR coordination that is required to facilitate the handover.

The handover process of the embodiments can be utilized with a variety of similar architectures and has been provided by way of example and not limitation. As long as the EID of the UE maps to the correct RLOC for the attached TR, the associated UPF in a distributed architecture are also reachable via the same RLOC. Although in the simplest case there is a 1:1 correspondence between the gNodeB and any UPFs, the system can be expanded to incorporate more complex cases using the same principles.

The embodiments of this handover process provide various advantages over the art. By using LISP, the embodiments get the benefit of shortest path forwarding for mobility management. Coordinating knowledge of pending handover with LISP permits a redirect of traffic from the source egress TR to the target egress TR via the source ingress TR once the UE is no longer reachable from the source TR, and in the process of connecting with the target TR. Informing the target egress TR of a pending handover permits it to receive and buffer traffic for an EID prior to re-attachment of the EID to the network eliminating loss. Eliminating the concept of bearers (which manifest themselves as differentiated services code points (DSCPs)) permits significant simplification of the handover process. These processes collectively mitigate the effects of a “break before make” style of mobility.

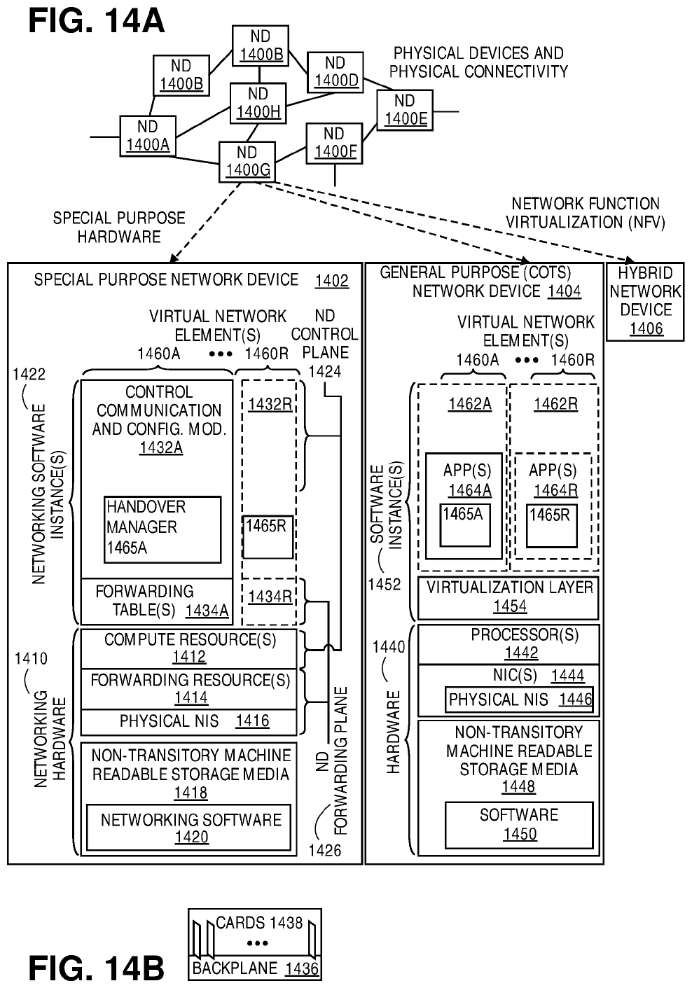

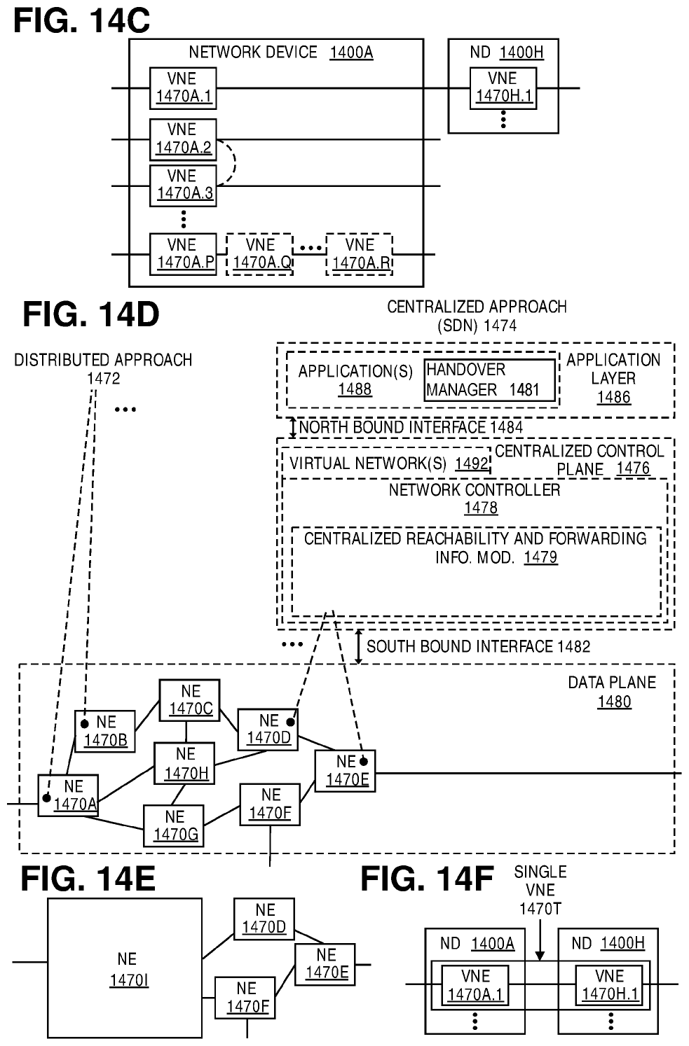

FIG. 14A illustrates connectivity between network devices (NDs) within an exemplary network, as well as three exemplary implementations of the NDs, according to some embodiments of the invention. FIG. 14A shows NDs 1400A-H, and their connectivity by way of lines between 1400A-1400B, 1400B-1400C, 1400C-1400D, 1400D-1400E, 1400E-1400F, 1400F-1400G, and 1400A-1400G, as well as between 1400H and each of 1400A, 1400C, 1400D, and 1400G. These NDs are physical devices, and the connectivity between these NDs can be wireless or wired (often referred to as a link). An additional line extending from NDs 1400A, 1400E, and 1400F illustrates that these NDs act as ingress and egress points for the network (and thus, these NDs are sometimes referred to as edge NDs; while the other NDs may be called core NDs).

Two of the exemplary ND implementations in FIG. 14A are: 1) a special-purpose network device 1402 that uses custom application-specific integrated-circuits (ASICs) and a special-purpose operating system (OS); and 2) a general-purpose network device 1404 that uses common off-the-shelf (COTS) processors and a standard OS.

The special-purpose network device 1402 includes networking hardware 1410 comprising compute resource(s) 1412 (which typically include a set of one or more processors), forwarding resource(s) 1414 (which typically include one or more ASICs and/or network processors), and physical network interfaces (NIs) 1416 (sometimes called physical ports), as well as non-transitory machine-readable storage media 1418 having stored therein networking software 1414. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 1400A-H. During operation, the networking software 1420 may be executed by the networking hardware 1410 to instantiate a set of one or more networking software instance(s) 1422. Each of the networking software instance(s) 1422, and that part of the networking hardware 1410 that executes that network software instance (be it hardware dedicated to that networking software instance and/or time slices of hardware temporally shared by that networking software instance with others of the networking software instance(s) 1422), form a separate virtual network element 1430A-R. Each of the virtual network element(s) (VNEs) 1430A-R includes a control communication and configuration module 1432A-R (sometimes referred to as a local control module or control communication module) and forwarding table(s) 1434A-R, such that a given virtual network element (e.g., 1430A) includes the control communication and configuration module (e.g., 1432A), a set of one or more forwarding table(s) (e.g., 1434A), and that portion of the networking hardware 1410 that executes the virtual network element (e.g., 1430A).

The special-purpose network device 1402 is often physically and/or logically considered to include: 1) a ND control plane 1424 (sometimes referred to as a control plane) comprising the compute resource(s) 1412 that execute the control communication and configuration module(s) 1432A-R; and 2) a ND forwarding plane 1426 (sometimes referred to as a forwarding plane, a user plane, or a media plane) comprising the forwarding resource(s) 1414 that utilize the forwarding table(s) 1434A-R and the physical NIs 1416. By way of example, where the ND is a router (or is implementing routing functionality), the ND control plane 1424 (the compute resource(s) 1412 executing the control communication and configuration module(s) 1432A-R) is typically responsible for participating in controlling how data (e.g., packets) is to be routed (e.g., the next hop for the data and the outgoing physical NI for that data) and storing that routing information in the forwarding table(s) 1434A-R, and the ND forwarding plane 1426 is responsible for receiving that data on the physical NIs 1416 and forwarding that data out the appropriate ones of the physical NIs 1416 based on the forwarding table(s) 1434A-R.

FIG. 14B illustrates an exemplary way to implement the special-purpose network device 1402 according to some embodiments of the invention. FIG. 14B shows a special-purpose network device including cards 1438 (typically hot pluggable). While in some embodiments the cards 1438 are of two types (one or more that operate as the ND forwarding plane 1426 (sometimes called line cards), and one or more that operate to implement the ND control plane 1424 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 1436 (e.g., a first full mesh coupling the line cards and a second full mesh coupling all of the cards).

Returning to FIG. 14A, the general-purpose network device 1404 includes hardware 1440 comprising a set of one or more processor(s) 1442 (which are often COTS processors) and network interface controller(s) 1444 (NICs; also known as network interface cards) (which include physical NIs 1446), as well as non-transitory machine-readable storage media 1448 having stored therein software 1450. During operation, the processor(s) 1442 execute the software 1450 to instantiate one or more sets of one or more applications 1464A-R. While one embodiment does not implement virtualization, alternative embodiments may use different forms of virtualization. For example, in one such alternative embodiment the virtualization layer 1454 represents the kernel of an operating system (or a shim executing on a base operating system) that allows for the creation of multiple instances 1462A-R called software containers that may each be used to execute one (or more) of the sets of applications 1464A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 1454 represents a hypervisor (sometimes referred to as a virtual machine monitor (VMM)) or a hypervisor executing on top of a host operating system, and each of the sets of applications 1464A-R is run on top of a guest operating system within an instance 1462A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1440, directly on a hypervisor (in which case the unikernel is sometimes described as running within a LibOS virtual machine), or in a software container, embodiments can be implemented fully with unikernels running directly on a hypervisor represented by virtualization layer 1454, unikernels running within software containers represented by instances 1462A-R, or as a combination of unikernels and the above-described techniques (e.g., unikernels and virtual machines both run directly on a hypervisor, unikernels and sets of applications that are run in different software containers).

The instantiation of the one or more sets of one or more applications 1464A-R, as well as virtualization if implemented, are collectively referred to as software instance(s) 1452. Each set of applications 1464A-R, corresponding virtualization construct (e.g., instance 1462A-R) if implemented, and that part of the hardware 1440 that executes them (be it hardware dedicated to that execution and/or time slices of hardware temporally shared), forms a separate virtual network element(s) 1460A-R. The applications 1464A-R may include a handover manager 1465A-R that may encompass the components of a distributed user plane function, tunnel routers and similar components and processes as described herein, in particular to the processes describe with reference to FIGS. 12-15.

The virtual network element(s) 1460A-R perform similar functionality to the virtual network element(s) 1430A-R—e.g., similar to the control communication and configuration module(s) 1432A and forwarding table(s) 1434A (this virtualization of the hardware 1440 is sometimes referred to as network function virtualization (NFV)). Thus, NFV may be used to consolidate many network equipment types onto industry standard high-volume server hardware, physical switches, and physical storage, which could be located in Data centers, NDs, and customer premise equipment (CPE). While embodiments of the invention are illustrated with each instance 1462A-R corresponding to one VNE 1460A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 1462A-R to VNEs also apply to embodiments where such a finer level of granularity and/or unikernels are used.

In certain embodiments, the virtualization layer 1454 includes a virtual switch that provides similar forwarding services as a physical Ethernet switch. Specifically, this virtual switch forwards traffic between instances 1462A-R and the NIC(s) 1444, as well as optionally between the instances 1462A-R; in addition, this virtual switch may enforce network isolation between the VNEs 1460A-R that by policy are not permitted to communicate with each other (e.g., by honoring virtual local area networks (VLANs)).

The third exemplary ND implementation in FIG. 14A is a hybrid network device 1406, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 1402) could provide for para-virtualization to the networking hardware present in the hybrid network device 1406.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also, in all of the above exemplary implementations, each of the VNEs (e.g., VNE(s) 1430A-R, VNEs 1460A-R, and those in the hybrid network device 1406) receives data on the physical NIs (e.g., 1416, 1446) and forwards that data out the appropriate ones of the physical NIs (e.g., 1416, 1446). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 14C illustrates various exemplary ways in which VNEs may be coupled according to some embodiments of the invention. FIG. 14C shows VNEs 1470A.1-1470A.P (and optionally VNEs 1470A.Q-1470A.R) implemented in ND 1400A and VNE 1470H.1 in ND 1400H. In FIG. 14C, VNEs 1470A.1-P are separate from each other in the sense that they can receive packets from outside ND 1400A and forward packets outside of ND 1400A; VNE 1470A.1 is coupled with VNE 1470H.1, and thus they communicate packets between their respective NDs; VNE 1470A.2-1470A.3 may optionally forward packets between themselves without forwarding them outside of the ND 1400A; and VNE 1470A.P may optionally be the first in a chain of VNEs that includes VNE 1470A.Q followed by VNE 1470A.R (this is sometimes referred to as dynamic service chaining, where each of the VNEs in the series of VNEs provides a different service—e.g., one or more layer 4-7 network services). While FIG. 14C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 14A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 14A may also host one or more such servers (e.g., in the case of the general purpose network device 1404, one or more of the software instances 1462A-R may operate as servers; the same would be true for the hybrid network device 1406; in the case of the special-purpose network device 1402, one or more such servers could also be run on a virtualization layer executed by the compute resource(s) 1412); in which case the servers are said to be co-located with the VNEs of that ND.

A virtual network is a logical abstraction of a physical network (such as that in FIG. 14A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on an NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 14D illustrates a network with a single network element on each of the NDs of FIG. 14A, and within this straight forward approach contrasts a traditional distributed approach (commonly used by traditional routers) with a centralized approach for maintaining reachability and forwarding information (also called network control), according to some embodiments of the invention. Specifically, FIG. 14D illustrates network elements (NEs) 1470A-H with the same connectivity as the NDs 1400A-H of FIG. 14A.

FIG. 14D illustrates that the distributed approach 1472 distributes responsibility for generating the reachability and forwarding information across the NEs 1470A-H; in other words, the process of neighbor discovery and topology discovery is distributed.

For example, where the special-purpose network device 1402 is used, the control communication and configuration module(s) 1432A-R of the ND control plane 1424 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 1470A-H (e.g., the compute resource(s) 1412 executing the control communication and configuration module(s) 1432A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 1424. The ND control plane 1424 programs the ND forwarding plane 1426 with information (e.g., adjacency and route information) based on the routing structure(s). For example, the ND control plane 1424 programs the adjacency and route information into one or more forwarding table(s) 1434A-R (e.g., Forwarding Information Base (FIB), Label Forwarding Information Base (LFIB), and one or more adjacency structures) on the ND forwarding plane 1426. For layer 2 forwarding, the ND can store one or more bridging tables that are used to forward data based on the layer 2 information in that data. While the above example uses the special-purpose network device 1402, the same distributed approach 1472 can be implemented on the general-purpose network device 1404 and the hybrid network device 1406.

FIG. 14D illustrates that a centralized approach 1474 (also known as software defined networking (SDN)) that decouples the system that makes decisions about where traffic is sent from the underlying systems that forwards traffic to the selected destination. The illustrated centralized approach 1474 has the responsibility for the generation of reachability and forwarding information in a centralized control plane 1476 (sometimes referred to as an SDN control module, controller, network controller, OpenFlow controller, SDN controller, control plane node, network virtualization authority, or management control entity), and thus the process of neighbor discovery and topology discovery is centralized. The centralized control plane 1476 has a south bound interface 1482 with a user plane 1480 (sometime referred to the infrastructure layer, network forwarding plane, or forwarding plane (which should not be confused with a ND forwarding plane)) that includes the NEs 1470A-H (sometimes referred to as switches, forwarding elements, user plane elements, or nodes). The centralized control plane 1476 includes a network controller 1478, which includes a centralized reachability and forwarding information module 1479 that determines the reachability within the network and distributes the forwarding information to the NEs 1470A-H of the user plane 1480 over the south bound interface 1482 (which may use the OpenFlow protocol). Thus, the network intelligence is centralized in the centralized control plane 1476 executing on electronic devices that are typically separate from the NDs.

For example, where the special-purpose network device 1402 is used in the user plane 1480, each of the control communication and configuration module(s) 1432A-R of the ND control plane 1424 typically include a control agent that provides the VNE side of the south bound interface 1482. In this case, the ND control plane 1424 (the compute resource(s) 1412 executing the control communication and configuration module(s) 1432A-R) performs its responsibility for participating in controlling how data (e.g., packets) is to be routed (e.g., the next hop for the data and the outgoing physical NI for that data) through the control agent communicating with the centralized control plane 1476 to receive the forwarding information (and in some cases, the reachability information) from the centralized reachability and forwarding information module 1479 (it should be understood that in some embodiments of the invention, the control communication and configuration module(s) 1432A-R, in addition to communicating with the centralized control plane 1476, may also play some role in determining reachability and/or calculating forwarding information—albeit less so than in the case of a distributed approach; such embodiments are generally considered to fall under the centralized approach 1474, but may also be considered a hybrid approach). The control communication and configuration module 932A-R may implement a handover manager 1433A-R that may encompass the components of a distributed user plane function, tunnel routers and similar components and processes as described herein, in particular to the processes describe with reference to FIGS. 12-15.

While the above example uses the special-purpose network device 1402, the same centralized approach 1474 can be implemented with the general purpose network device 1404 (e.g., each of the VNE 1460A-R performs its responsibility for controlling how data (e.g., packets) is to be routed (e.g., the next hop for the data and the outgoing physical NI for that data) by communicating with the centralized control plane 1476 to receive the forwarding information (and in some cases, the reachability information) from the centralized reachability and forwarding information module 1479; it should be understood that in some embodiments of the invention, the VNEs 1460A-R, in addition to communicating with the centralized control plane 1476, may also play some role in determining reachability and/or calculating forwarding information—albeit less so than in the case of a distributed approach) and the hybrid network device 1406. In fact, the use of SDN techniques can enhance the NFV techniques typically used in the general-purpose network device 1404 or hybrid network device 1406 implementations as NFV is able to support SDN by providing an infrastructure upon which the SDN software can be run, and NFV and SDN both aim to make use of commodity server hardware and physical switches.

FIG. 14D also shows that the centralized control plane 1476 has a north bound interface 1484 to an application layer 1486, in which resides application(s) 1488. The centralized control plane 1476 has the ability to form virtual networks 1492 (sometimes referred to as a logical forwarding plane, network services, or overlay networks (with the NEs 1470A-H of the user plane 1480 being the underlay network)) for the application(s) 1488. Thus, the centralized control plane 1476 maintains a global view of all NDs and configured NEs/VNEs, and it maps the virtual networks to the underlying NDs efficiently (including maintaining these mappings as the physical network changes either through hardware (ND, link, or ND component) failure, addition, or removal). The control communication and configuration module 979 or applications 988 may implement a handover manager 1481 that may encompass the components of a distributed user plane function, tunnel routers and similar components and processes as described herein, in particular to the processes describe with reference to FIGS. 12-15.

While FIG. 14D shows the distributed approach 1472 separate from the centralized approach 1474, the effort of network control may be distributed differently or the two combined in certain embodiments of the invention. For example: 1) embodiments may generally use the centralized approach (SDN) 1474, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 1474 but may also be considered a hybrid approach.

While FIG. 14D illustrates the simple case where each of the NDs 1400A-H implements a single NE 1470A-H, it should be understood that the network control approaches described with reference to FIG. 14D also work for networks where one or more of the NDs 1400A-H implement multiple VNEs (e.g., VNEs 1430A-R, VNEs 1460A-R, those in the hybrid network device 1406). Alternatively, or in addition, the network controller 1478 may also emulate the implementation of multiple VNEs in a single ND. Specifically, instead of (or in addition to) implementing multiple VNEs in a single ND, the network controller 1478 may present the implementation of a VNE/NE in a single ND as multiple VNEs in the virtual networks 1492 (all in the same one of the virtual network(s) 1492, each in different ones of the virtual network(s) 1492, or some combination). For example, the network controller 1478 may cause an ND to implement a single VNE (a NE) in the underlay network, and then logically divide up the resources of that NE within the centralized control plane 1476 to present different VNEs in the virtual network(s) 1492 (where these different VNEs in the overlay networks are sharing the resources of the single VNE/NE implementation on the ND in the underlay network).

On the other hand, FIGS. 14E and 14F respectively illustrate exemplary abstractions of NEs and VNEs that the network controller 1478 may present as part of different ones of the virtual networks 1492. FIG. 14E illustrates the simple case of where each of the NDs 1400A-H implements a single NE 1470A-H (see FIG. 14D), but the centralized control plane 1476 has abstracted multiple of the NEs in different NDs (the NEs 1470A-C and G-H) into (to represent) a single NE 1470I in one of the virtual network(s) 1492 of FIG. 14D, according to some embodiments of the invention. FIG. 14E shows that in this virtual network, the NE 1470I is coupled to NE 1470D and 1470F, which are both still coupled to NE 1470E.

FIG. 14F illustrates a case where multiple VNEs (VNE 1470A.1 and VNE 1470H.1) are implemented on different NDs (ND 1400A and ND 1400H) and are coupled to each other, and where the centralized control plane 1476 has abstracted these multiple VNEs such that they appear as a single VNE 1470T within one of the virtual networks 1492 of FIG. 14D, according to some embodiments of the invention. Thus, the abstraction of a NE or VNE can span multiple NDs.

While some embodiments of the invention implement the centralized control plane 1476 as a single entity (e.g., a single instance of software running on a single electronic device), alternative embodiments may spread the functionality across multiple entities for redundancy and/or scalability purposes (e.g., multiple instances of software running on different electronic devices).

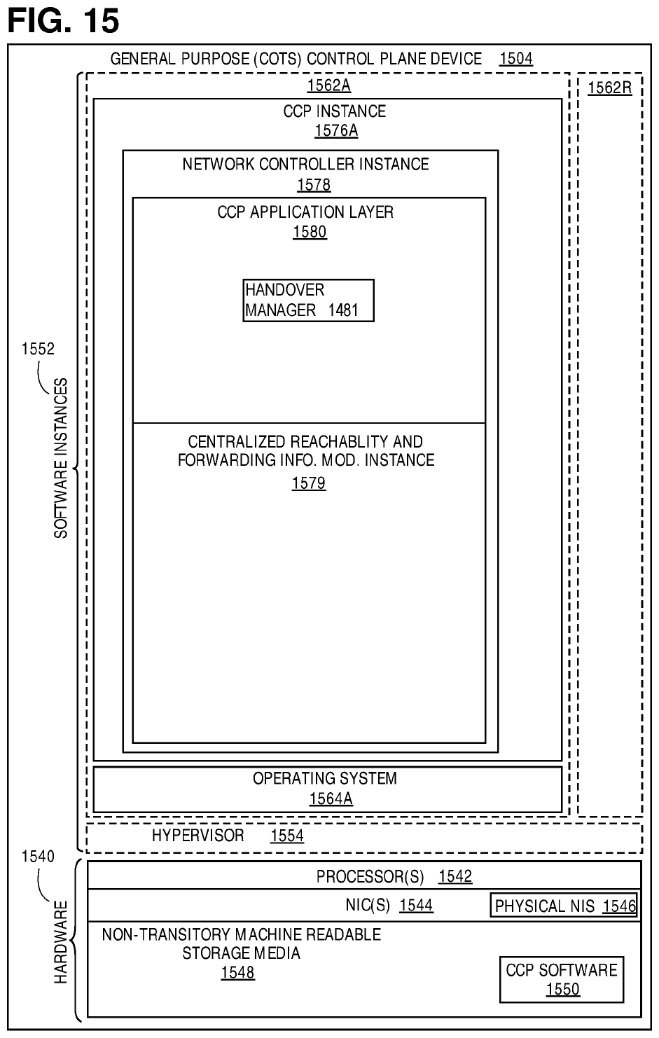

Similar to the network device implementations, the electronic device(s) running the centralized control plane 1476, and thus the network controller 1478 including the centralized reachability and forwarding information module 1479, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 15 illustrates, a general-purpose control plane device 1504 including hardware 1540 comprising a set of one or more processor(s) 1542 (which are often COTS processors) and network interface controller(s) 1544 (NICs; also known as network interface cards) (which include physical NIs 1546), as well as non-transitory machine-readable storage media 1548 having stored therein centralized control plane (CCP) software 1550.

In embodiments that use compute virtualization, the processor(s) 1542 typically execute software to instantiate a virtualization layer 1554 (e.g., in one embodiment the virtualization layer 1554 represents the kernel of an operating system (or a shim executing on a base operating system) that allows for the creation of multiple instances 1562A-R called software containers (representing separate user spaces and also called virtualization engines, virtual private servers, or jails) that may each be used to execute a set of one or more applications; in another embodiment the virtualization layer 1554 represents a hypervisor (sometimes referred to as a virtual machine monitor (VMM)) or a hypervisor executing on top of a host operating system, and an application is run on top of a guest operating system within an instance 1562A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 1540, directly on a hypervisor represented by virtualization layer 1554 (in which case the unikernel is sometimes described as running within a LibOS virtual machine), or in a software container represented by one of instances 1562A-R). Again, in embodiments where compute virtualization is used, during operation an instance of the CCP software 1550 (illustrated as CCP instance 1576A) is executed (e.g., within the instance 1562A) on the virtualization layer 1554. In embodiments where compute virtualization is not used, the CCP instance 1576A is executed, as a unikernel or on top of a host operating system, on the “bare metal” general purpose control plane device 1504. The instantiation of the CCP instance 1576A, as well as the virtualization layer 1554 and instances 1562A-R if implemented, are collectively referred to as software instance(s) 1552.

In some embodiments, the CCP instance 1576A includes a network controller instance 1578. The network controller instance 1578 includes a centralized reachability and forwarding information module instance 1579 (which is a middleware layer providing the context of the network controller 1478 to the operating system and communicating with the various NEs), and an CCP application layer 1580 (sometimes referred to as an application layer) over the middleware layer (providing the intelligence required for various network operations such as protocols, network situational awareness, and user-interfaces). At a more abstract level, this CCP application layer 1580 within the centralized control plane 1476 works with virtual network view(s) (logical view(s) of the network) and the middleware layer provides the conversion from the virtual networks to the physical view. The CCP application layer 1580 may implement a handover manager 1481 that may encompass the components of a distributed user plane function (UPF), tunnel routers and similar components and processes as described herein, in particular to the processes describe with reference to FIGS. 12-15.

The centralized control plane 1476 transmits relevant messages to the user plane 1480 based on CCP application layer 1580 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the user plane 1480 may receive different messages, and thus different forwarding information. The user plane 1480 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the user plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the user plane 1480, the packet (or a subset of the packet header and content) is typically forwarded to the centralized control plane 1476. The centralized control plane 1476 will then program forwarding table entries into the user plane 1480 to accommodate packets belonging to the flow of the unknown packet. Once a specific forwarding table entry has been programmed into the user plane 1480 by the centralized control plane 1476, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method implemented by a network device in a cellular communication network, the method to improve handover processing by a source tunnel router (TR) where the source TR forwards traffic destined for a user equipment (UE) that is transferring its connection to a target gNodeB, a target user plane function (UPF) and a target TR to enable mobility within the cellular communication network without anchor points, the method comprising:
receiving a routing locator (RLOC) of the target TR connected to the target UPF and the target gNodeB from a session management function (SMF);
redirecting traffic with an endpoint identifier (EID) of the UE to the target TR;
receiving a release message from the SMF; and
removing state for the EID of the UE.

2. The method of claim 1, further comprising:
preparing the UE for handover to the target gNodeB after a handover decision is made.

3. The method of claim 1, wherein redirecting the traffic with the EID of the UE overwrites an RLOC in traffic received from the network with the RLOC of the target TR.

4. The method of claim 1, further comprising:
sending a LISP EID handover request to the target TR.

5. The method of claim 1, further comprising:
receiving an EID handover request from a source gNodeB.

6. A method implemented by a network device in a cellular communication network, the method to improve handover processing by a target tunnel router (TR) and target gNodeB where the target TR and target gNodeB relay traffic between a user equipment (UE) and other devices connected to the cellular communication network to enable mobility within the cellular communication network without anchor points, the method comprising:
receiving redirected traffic for the UE from a source TR;
receiving upstream traffic from the UE;
forwarding the upstream traffic to a correspondent; and
sending an update to a location identifier separation protocol (LISP) mapping server (MS) indicating an endpoint identifier (EID) to the target TR identified by routing locator (RLOC) mapping.

7. The method of claim 6, further comprising:
forwarding buffered traffic from the source TR to the UE after the UE connects to the target gNodeB.

8. The method of claim 6, further comprising:
executing handover in combination with the target gNodeB to enable the UE to attach to the target gNodeB.

9. The method of claim 6, further comprising:
sending a LISP EID handover acknowledgement to the source TR in response to a LISP EID handover request.

10. The method of claim 6, further comprising:
receiving traffic for the UE from remote tunnel routers.

11. A network device in a cellular communication network to implement a method to improve handover processing by a source tunnel router (TR) where the source TR forwards traffic destined for a user equipment (UE) that is transferring its connection to a target gNodeB, a target user plane function (UPF) and a target TR to enable mobility within the cellular communication network without anchor points, the network device comprising:
a non-transitory computer-readable storage medium having stored therein a handover manager; and
a processor coupled to the non-transitory computer-readable storage medium, the processor to execute the handover manager, the handover manager to receive a routing locator (RLOC) of the target TR connected to the target UPF and the target gNodeB from a session management function (SMF), to redirect traffic with an endpoint identifier (EID) of the UE to the target TR, to receive a release message from the SMF, and to remove state for the EID of the UE.

12. The network device of claim 11, wherein the handover manager is further to prepare the UE for handover to the target gNodeB after a handover decision is made.

13. The network device of claim 11, wherein redirecting the traffic with the EID of the UE overwrites an RLOC in traffic received from the network with the RLOC of the target TR.

14. The network device of claim 11, wherein the handover manager is further to send a LISP EID handover request to the target TR.

15. The network device of claim 11, wherein the handover manger is further to receive an EID handover request from a source gNodeB.

16. A network device in a cellular communication network to implement a method to improve handover processing by a target tunnel router (TR) and target gNodeB where the target TR and target gNodeB relay traffic between a user equipment (UE) and other devices connected to the cellular communication network to enable mobility within the cellular communication network without anchor points, the network device comprising:
a non-transitory computer-readable medium having stored therein a handover manager; and
a processor coupled to the non-transitory computer-readable medium, the processor to execute the handover manager, the handover manager to receive redirected traffic for the UE from a source TR, to receive upstream traffic from the UE, to forward the upstream traffic to a correspondent, and to send an update to a location identifier separation protocol (LISP) mapping server (MS) indicating an endpoint identifier (EID) to the target TR identified by routing locator (RLOC) mapping.

17. The network device of claim 16, wherein the handover manager is further to forward buffered traffic from the source TR to the UE after the UE connects to the target gNodeB.

18. The network device of claim 16, wherein the handover manager is further to execute handover in combination with the target gNodeB to enable the UE to attach to the target gNodeB.

19. The network device of claim 16, wherein the handover manager is further to send a LISP EID handover acknowledgement to the source TR in response to a LISP EID handover request.

20. The network device of claim 16, wherein the handover manager is further to receive traffic for the UE from remote tunnel routers.
